(19) United States
(12) Patent Application Publication
(10) Pub. No.: US 2014/0131543 A1
(43) Pub. Date: May 15, 2014

(54) DEVICE FIXING STRUCTURE

(71) Applicant: Mizuho Norikoshi-cho Nakagawa-ku, Nagoya-city (JP)

(72) Inventor: Toshihiro Goto, Nagoya-city (JP)

(73) Assignee: MIZUHO GOUSEI KOGYOSYO CO., LTD., Nagoya-city (JP)

(21) Appl. No.: 14/113,378

(22) PCT Filed: Nov. 15, 2012
(86) PCT No.: PCT/JP2012/079648

§ 371 Date: Oct. 22, 2013

(51) Int. Cl. F16M 11/04

(52) U.S. Cl. CPC F16M 11/043
USPC 248/429

(57) ABSTRACT

A device is disposed through a base that is slidable along a rail, and flange shaped engagement edge portions extending along with side edges of the rail is engaged with a pair of opposed base side engaging means provided on the base, and a resin base side spur tooth portion with a desired width provided on the base is meshed with a resin rail side spur tooth portion with substantially the same width provided on a side surface portion of the rail so that the base is not made a position gap, whereby the base is fixed to the rail. To enable fixation of a device formed into an odd shape, the base is vertically divided into two parts so that an upper member can move on an axis with respect to a lower member.

### TECHNICAL FIELD

The present invention relates to a versatile and durable device fixing structure that can easily fix various kinds of devices having different sizes/shapes so as to enable easy positional adjustment and does not loosen fixation even though force is repeatedly applied thereto. In more detail, the present invention relates to a strong device fixing structure that fixes an acoustic effector at a desired position where the acoustic operation can be easily operated and hardly causes a displacement or damage even though it is stepped by tips of a toe for operations.

### BACKGROUND ART

At the time of playing an electronic music instrument, to improve an acoustic effect of sound produced from a sound source, an effector device is used. A power supply cable and a signal cable are wired with respect to each effector device, each effector device is fixed to an effector board placed on a floor, and pedals are operated by tips of a toe even during performance. Japanese Unexamined Patent Application Publication No. 2011-548703 discloses a technology that fixes an effector to an effector fixing base and facilitates replacement of an effector, and separates a space in which cable wiring lines cross each other below the effector fixing base so that the cable wiring lines do not obstruct the performance.

However, when the effector fixing base is fixed to an effector board through screws, the screws must be removed and a position of the fixing base must be adjusted even in a case where slightly changing the position is desired. On the other hand, when a device is fixed with use of a hook-and-loop fastener, adjustment of a position is easy, whereas sufficient retention force cannot be obtained in some cases since rubber leg portions are protruded from four corners of a device bottom portion, the retention force of the hook-and-loop fastener may be lowered due to adhesion of dust, and a positional displacement of the effector fixing base may possibly occur because of vibration during conveyance or a pedal operation during performance. Further, when a double coated adhesive tape is used for fixation, there occurs a problem that the effector device is stained.

Furthermore, the technology for disposing an electronic device to a rail so as to enable positional adjustment is disclosed in the following literatures. Japanese Unexamined Patent Application Publication No. 2002-16382 discloses the technology of forming irregularities on respective opposed surfaces of an attachment adapter for attaching a device and a fixture for fitting the attachment adapter and enabling positional adjustment in the range where the irregularities are formed in a direction crossing a support rail. However, according to this technology, since the attachment adapter for the positional adjustment engages with the fixture through the surfaces having the irregularities and the irregularities associated with both the device and the attachment adapter must be formed in advance, there is a problem that a device to be disposed is restricted, the range where the positional adjustment is possible is narrow, and the versatility is poor.

Moreover, the technology of attaching an electronic device to a rail is disclosed in the following literature. Japanese Unexamined Utility Model Application Publication No. 1987-126878 discloses the technology of a fitting structure for providing a jagged blade on an end face at edge of a rail, loading a groove side surface of a bottom portion on a device side with an elastic member such as a rubber sheet, and allowing the jagged blade to bide into the rubber sheet, thereby effecting fixation. Additionally, Japanese Unexamined Utility Model Application Publication No. 1985-93406 discloses the technology of a tool attachment fitting rail having irregularities on an end edge of the fitting rail. However, according to these technologies, since a board thickness that forms the rail is small, force is intensively applied to a fitting portion of a device to be fitted, and there is a problem that the fitting portion is plastically deformed or scraped to loosen fixation when the fitting portion of the device to be fitted is made of a rubber sheet or a resin. Further, for example, when strong force, e.g., stepping force in case of an effecter device is repeatedly applied, there is also a problem that a fixed position is displaced or the fitting portion is scraped and damaged so that fixation cannot be firmly maintained.

Furthermore, Japanese Unexamined Patent Application Publication No. 1987-86797 discloses the technology of a rail attaching configuration for an electrical device in which a bending spring leaf formed of a steel sheet or the like having a jagged blade formed at free end of one of the electrical device and the rail is provided between the electrical device and the rail and irregularities are provided on the other of the same. However, according to this technology, the bending leaf spring is provided to one of the device and the rail, a board thickness and a material are limited, and hence there is a problem that the jagged blade is scraped, the irregularities provided on the other are scraped to displace a fixed position, or the attachment portion is damaged when strong force is repeatedly applied, whereby fixation cannot be firmly maintained.

### CITATION LIST

### Patent Literatures

Patent Literature 1: Japanese Patent Application Publication No. 2011-548703

Patent Literature 2: Japanese Unexamined Patent Application Publication No. 2002-16382

Patent Literature 3: Japanese Unexamined Utility Model Application Publication No. 1987-126878

Patent Literature 4: Japanese Unexamined Utility Model Application Publication No. 1985-93406

Patent Literature 5: Japanese Unexamined Patent Application Publication No. 1987-86797

### DISCLOSURE OF INVENTION

### Problem to be Solved by the Invention

A problem to be solved by the present invention is to provide a device fixing structure that easily fixes various kinds of devices having different sizes/shapes so as to enable positional adjustment and that does not loosen fixation even if force is repeatedly applied to a fixed device.

### Means for Solving Problem

As a first invention according to the present invention, there is provided a device fixing structure comprising: a rail extending in a linear form; and a base that is movable along a top surface of the rail, the rail comprising: flange-shaped engagement edge portions extending along both side edges thereof; and rail side engaging means on at least one of lateral sides of the rail, the base comprising: a flat portion arranged along the top surface of the rail; attaching means for attaching a device; and a pair of opposed base side engaging means that are engaged with the rail side engagement edge portions, any one of the base side engaging means including: sliding means that is slidable in a direction extending toward the rail; and slide locking means for locking the sliding means, the device fixing structure being configured so that the base side engaging means is meshed with the rail side engaging means and the slide locking means is locked to fix a position of the base in a state where the base is arranged at a desired position, or the base is movable in the extending direction of the rail in a state that the base side engaging means is detached from the rail side engaging means and the slide locking means is unlocked, wherein the flat portion comprises fixed position adjusting means which has a desired length in a direction crossing the extending direction of the rail and slides the device along a direction of the desired length to perform positional adjustment, the rail side engaging means comprises a rail side spur tooth portion having resin spur teeth with a desired width bonded thereto at a position of a rail side surface portion below the engagement edge portion, and the base side engaging means facing the rail side engaging means comprises a base side spur tooth portion constituted of resin spur teeth with substantially the same width as the rail side spur tooth portion on an opposed portion relative to the rail side spur tooth portion.

Here, the rail is not restricted to a linearly extending rail, and it may be a rail that is smoothly bent. As the rail, a DIN rail that is an industrially standardized article is preferable, but it is not restricted to an industrially standardized article, and a rail formed by bending a metal sheet or a rail formed by cutting a metal block may be used. The rail side engaging means is preferably engaging means for holding flange portions of the DIN rail.

Further, in regard to the sliding means included in the base side engaging means, the shaft body may slide in the cylindrical body, or sliding may be effected across the protruded bar. The slide locking means may be various locking means based on, e.g., meshing of a convex portion and a concave portion, fitting of a pin into a hole, or engagement of a claw with a groove. The base side engaging means maybe formed of a single member or may be formed of a plurality of integrally configured members. Furthermore, in regard to the attaching means for attaching the device to the base, fixation may be achieved by using screws alone, but both the screws and a string may be used, and the attaching means is not restricted as long as it is means for enabling the device to be attached to the base.

The rail side engaging means includes the rail side spur tooth portion having spur teeth bonded to the side surface portion of the rail. In the spur teeth, crest portions and trough portions forming the tooth portion are continuously aligned, and a direction extending along the crest portions and the trough portions is arranged to cross a direction parallel to the rail. The resin spur teeth with a desired width parallel to a direction extending along the crest portions and the trough portions are bonded to the side surface portion of the rail by a double coated adhesive tape or an adhesive, thereby forming the rail side spur tooth portion. As the resin forming the spur teeth, a nylon resin is preferable, but it is not restricted. When a pitch of the spur teeth is, e.g., 1 mm and the teeth are continuously formed with a length along the rail, installation of the device can be adjusted at narrow intervals of 1 mm. As a result, it is possible to cope with a need for slightly changing a position of the device, and the device can be easily adjusted and fixed at a desired position.

The width of the resin spur teeth can be extended up to a height of the side surface portion of the rail. For example, when the rail is the DIN rail, a height of approximately 3 mm can be adopted. Moreover, as a thickness of the resin spur tooth portion, a thickness that enables forming a desired pitch can suffice, and it is not restricted. The resin spur teeth do not have to be necessarily continuously provided over the entire length of the rail, and they may be formed on one surface of the rail or part of the rail in the length direction. The base side spur tooth portion included in the base side engaging means is formed with substantially the same width as the width of the rail side spur tooth portion. The base side spur tooth portion and the rail side spur tooth portion are formed with the same width of, e.g., 3 mm, and their resin spur teeth mesh with each other.

As a result, even if strong force is repeatedly applied, detachment does not occur, either the rail side spur teeth or the base side spur teeth do not scrape and damage the other, a position of the device or the base is not displaced even in case of the device to which strong force or vibration is repeatedly applied by an operation using a toe like an effector device that is operated by a toe, and an advantageous effect, i.e., higher durability than that in the conventional technology can be obtained.

Here, the first rail side engaging means may be formed on one of a pair of rails extending the same distance to interpose a space therebetween and the second rail side engaging means may be formed on the other rail so that the base can be arranged to get across a plurality of rails. The pair of rails are not restricted to rails linearly extending in parallel, and they may be rails extending in a curved state. Additionally, the base side engaging means engaged with the rail side engaging means may be installed so as to straddle and hold the pair of rails from the outer side, or it may be installed so as to reach the pair of rails from the inner side.

Fixation on the pair of rails that are apart from each other enables fixing an edge portion of the device near the end portion of the same even if the device has a large support surface that is supported on the base. Further, when three or more rails are arranged in parallel, positions of a plurality of devices having different sizes can be adjusted and fixed by selecting a rail placed near the end portion of the bottom surface of each device. When the plurality of rails are used in this manner and the device fixing structure according to the present invention is applied, a plurality of devices having different bottom surface sizes can be arranged with high density by effectively exploiting a planar space in which the rails are arranged, and they can be firmly fixed so that they cannot come off even if strong force is repeatedly applied.

In the first invention, the device fixing structure as a second invention according to the present invention is characterized in that the fixed position adjusting means comprises a slot extending along a length direction of the flat portion, a screw, and a nut, and the base portion is slid in a direction parallel to the slot and subjected to positional adjustment, and the screw is inserted into the slot and screwed and fixed to the nut.

Even if a portion to be fixed on the device side is not machined into a shape associated with the rails, forming each hole, into which a screw is inserted, in the fixing member in advance enables to fix the fixing member to the base through the screw. As a result, it is possible to exploit the present invention as a highly versatile device fixing structure that enables to dispose various objects such as small objects, e.g., an oil lighter or a doll to a desired position. Furthermore, when the rail surface is set upright and a small object is fixed, an exhibition board can be formed.

In the first or second invention, the device fixing structure of a third invention according to the present invention is characterized by comprising a device fixing member that fixes the device to the base, wherein the device fixing member comprises an upper member and a lower member that are separable, and the lower member is subjected to positional adjustment in the direction parallel to the rail and fixed, the upper member is overlapped and pivotally supported on the lower member, two columnar bodies that upwardly extend and are apart from each other are provided on a top surface of the upper member, and the two columnar bodies are brought into contact with an edge portion of the device, thereby supporting and fixing the device.

As a result, even if a bottom surface shape of the device to be fixed is an odd shape other than a rectangular shape, e.g., a circular shape, a trapezoidal shape, or a human sole shape, the upper member moves on the axis and the two shaft bodies support the edge portion of the device, thereby supporting the device. As a result, it is possible to exert an advantageous effect that even a device whose bottom surface has an odd shape can be firmly fixed by supporting an edge portion of the device.

In the first to third inventions, the device fixing structure as a fourth invention according to the present invention is characterized by comprising a device fixing member that fixes the device to the base, wherein the device fixing member comprises height adjusting means.

As a result, in case of fixing a plurality of devices to the rail, a fixing position in a height direction can be changed in accordance with each device. For example, in a plurality of devices arranged on an effector board, a device far from a performer is fixed at a high position and a device close to the performer is fixed at a low position so that the performer can hardly make mistakes.

In the first to fourth inventions, the device fixing structure as a fifth invention according to the present invention is characterized in that a separation space is provided between the rail and a platform where the device fixing structure is installed.

Since the separation space is present between the rail and the platform on which the rail is set, e.g., a floor or a wall, cable wiring lines extending from each electronic device fixed on the rail can be accommodated in the separation space. As a result, a performer of an electronic music instrument does not make mistakes by tripping over the distribution cables of the effector. Moreover, when a wall in a room is used as the platform and an object such as a picture frame or a doll is hanged on the rail that is a fixed rail configured to hang an object on the wall, part of the object, e.g., a wiring line or a protrusion of the doll can be accommodated in the separation space, and the object can be beautifully displayed with an appropriate interval.

### Effect of the Invention

According to the first invention of the present invention, it is possible to meet the need for slightly changing a position of a device, and the device can be easily adjusted and fixed to a desired position. Moreover, even if strong force is repeatedly applied, detachment does not occur, either the rail side spur teeth or the base side spur teeth do not scape and damage the other, a position of the device or the base is not displaced even though strong force or vibration is repeatedly applied to the device by an operation using a toe like an effector device operated by a toe, and an advantageous effect, i.e., high durability can be obtained as compared with the conventional technology.

According to the second invention of the present invention, it is possible to exploit this invention as the highly versatile device fixing structure that enables to dispose various objects, e.g., small objects like an oil lighter or a doll at desired positions.

According to the third invention of the present invention, even a device having an odd-shaped bottom surface can exert an advantageous effect that the device can be firmly fixed by supporting an edge portion of the device.

According to the fourth invention of the present invention, in case of fixing a plurality of devices to the rail, a position in a height direction can be changed in accordance with each device.

According to the fifth invention of the present invention, a performer of an electronic music instrument does not make mistakes in performance by tripping over a wiring cable of an effector. Moreover, part of an object, e.g., a wiring line or a protrusion of a doll can be accommodated in the separation space, and the object can be beautifully displayed with an appropriate interval.

### BRIEF DESCRIPTION OF DRAWINGS

FIG. 1 is a perspective view of an effector board including a plurality of rails (Example 1);

FIG. 2 is a perspective view for explaining a base laid across one rail (Example 1);

FIG. 3 is a perspective view for explaining a configuration of a coupled base obtained by coupling the bases (Example 1);

FIG. 4 is a perspective view for explaining the coupled base installed and laid across two rails (Example 1);

FIG. 5 is a perspective view for explaining the coupled bases arranged in parallel and an effector fixture (Example 1);

FIG. 6 is an arrangement plan of a state that a plurality of effectors are fixed to the rails (Example 1);

FIG. 7 is an explanatory view of a state that devices are fixed with a difference in height (Example 2); and

FIG. 8 is a perspective view for explaining a configuration of a pivotally supported device fixing member (Example 3).

### BEST MODE(S) FOR CARRYING OUT THE INVENTION

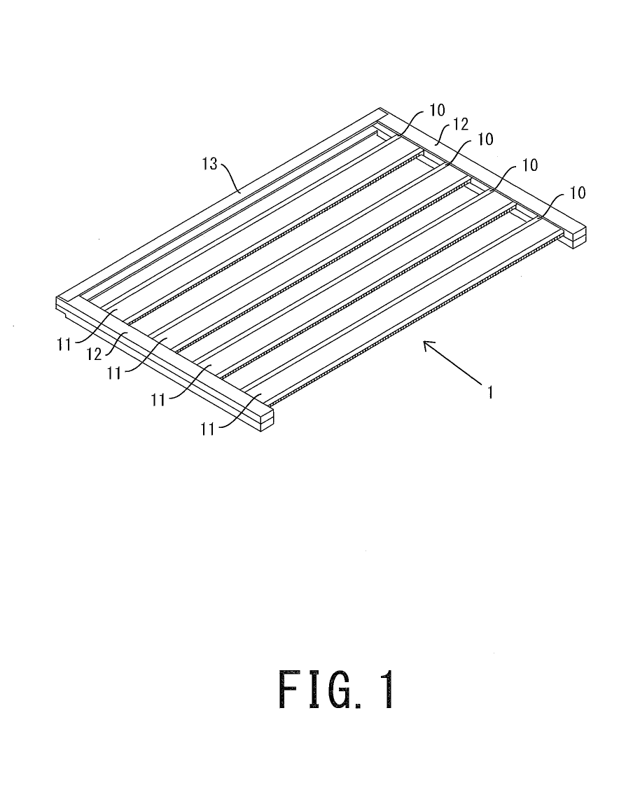

Embodiments for fixing a plurality of effector devices to an effector board will now be explained with reference to FIG. 1 to FIG. 6.

### Example 1

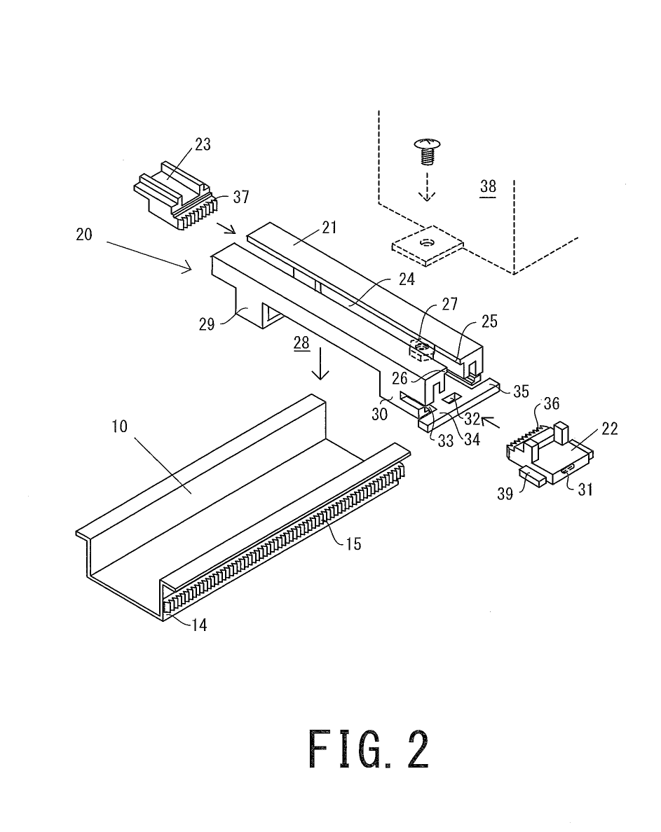

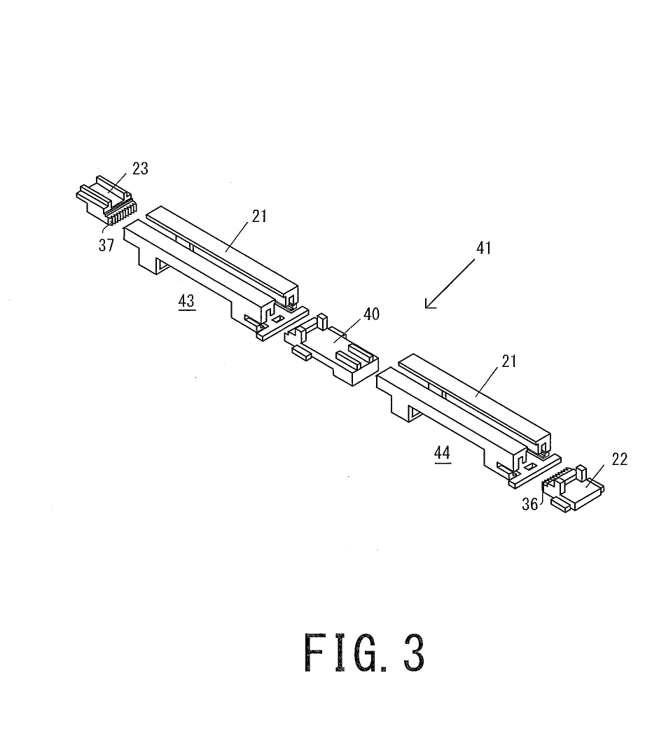

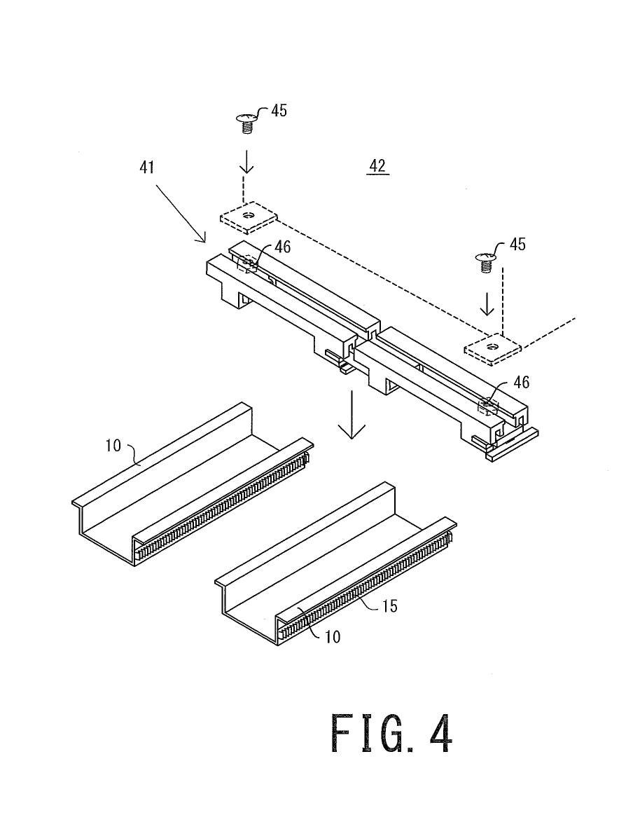

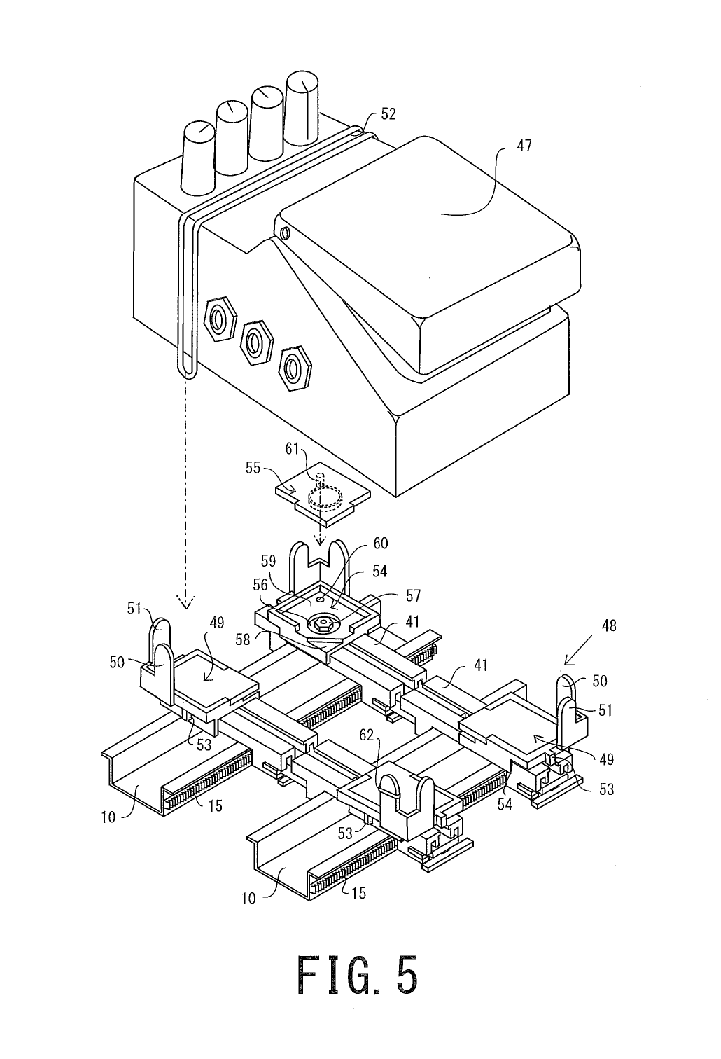

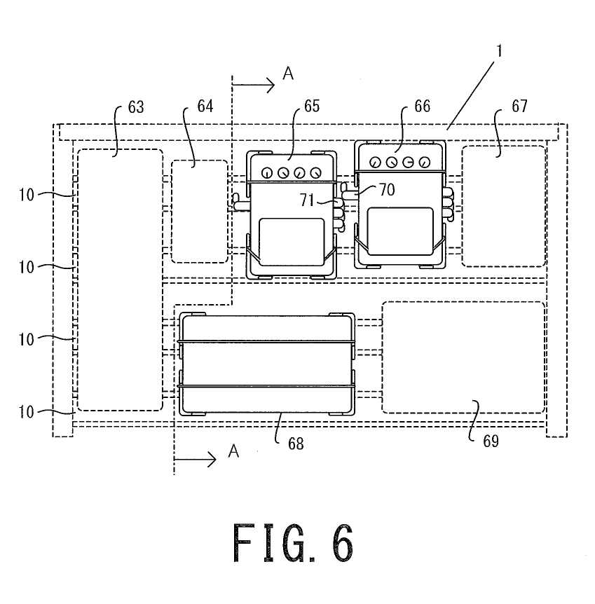

In Example 1, a fixation structure that fixes a plurality of effector devices to an effector board will now be explained as Example 1 where spur teeth are formed on both a side surface of each rail and base facing the rail side surface with reference to FIG. 1 to FIG. 6. FIG. 1 is a perspective view of an effector board 1 including a plurality of rails, FIG. 2 is a perspective view for explaining a base laid across one rail, and FIG. 3 is a perspective view for explaining a configuration of a coupled base obtained by coupling the bases. FIG. 4 is a perspective view for explaining the coupled base installed and laid across two rails. FIG. 5 is a perspective view for explaining the coupled bases arranged in parallel and an effector fixture. FIG. 6 is an arrangement plan of a state that a plurality of effectors are fixed to the rails.

In the effector board 1 to which effectors are fixed, four DIN rails 10 are aligned in parallel, and a groove portion of each DIN rail is covered with a lid 11. Each DIN rail is a flange-shaped engagement edge portion that has a wide “U”-shaped groove portion at a central portion thereof and has flange portions protruding on lateral sides along upper edges of the groove portion on both sides. Both side end portions of each DIN rail are held by resin frames 12, 12 with a separation space provided underneath. Front sides of the resin frames 12, 12 are held by a metal connecting material 13 having a substantially “U”-like shape. The resin frames 12 and the connecting material are screwed and fixed by non-illustrated screws. A separation space is likewise provided between the connecting material 13 and a floor present under this material.

Moreover, resin spur teeth configured by continuously forming spur teeth into bar shapes with a desired length are bonded to both rail side surface portions 14 below the flange portions of each DIN rail, thereby forming rail side spur tooth portions 15 (see FIG. 1 and FIG. 2). Rail side engaging means is constituted of the engagement edge portions and the rail side spur tooth portions 15.

A base 20 laid across one DIN rail 10 will now be explained. “Right” and “left” used in the following description mean illustrated directions in each perspective view, and they are not associated with each use mode. The base 20 is constituted of a central member 21 that is arranged to be laid across the DIN rail and a right end member 22 and a left end member 23 that are fitted to both end portions of a cylindrical portion of the central member (see FIG. 2). The right end member 22 and the left end member 23 form base side engaging means.

The central member 21 is a substantially cylindrical body having a slit 24 formed on the upper side and is arranged in a direction crossing the rail, and a top portion thereof is a flat portion. Protruding portions 25 and 26 extending along both edges of the slit function as an engagement portion for a nut 27 and a screw head that are slid in a slit lower space of the central member. A screw can slide along the slit 24 in a state that the nut 27 is loosened, and it serves as fixed portion adjusting means for adjusting and fixing a position of the base 20. Furthermore, a constricted portion 28 that is slightly wider than a width of the rail is formed below the central member, and rail straddling portions 29 and 30 that straddle the DIN rail are provided on both sides of the constricted portion 28. A locked portion 32, which is a hole in which a locking portion formed on each of later-described right end and left end members is locked, is formed in each of the rail straddling portions 29 and 30. In this embodiment, the locked portion 32 is a hole pierced toward the lower side, but it may be a concave portion that is not pierced.

Notch portions 33 are formed on both edges of the cylindrical body in the lower portion of the right rail straddling portion 30, thereby forming a tongue portion 34. A protruding push-down portion 35 is attached to both sides of the tongue portion 34. This push-down portion 35 is pushed down, a height of the right end hole of the cylindrical body is expanded in the vertical direction, and the right end member 22 is fitted. In Example 1, a locking portion 31 provided to protrude on the lower side of the right end member is locked in the locked portion 32, thereby forming slide locking means. In a bottom portion of the left rail straddling portion 29 to which a later-described left end member 23 is fitted, a locked portion in which a locking portion of the left end member 23 is locked is formed (not shown).

The right end member 22 is formed with a cross-sectional shape associated with a shape of the right cylindrical hole of the central member 21, a base side spur tooth portion 36 is formed on a side facing the rail, and the right end member 22 is inserted and fitted into the right cylindrical hole. A finger grip portion 39 projecting toward the lateral side from the cylindrical body is formed on a side edge portion, and it facilitates fitting of the right end member into the expanded cylindrical hole. The base side spur tooth portion 36 is allowed to mesh with the rail side spur tooth portion 15 that is formed to protrude below each rail flange portion and bonded to the rail side surface. Moreover, the convex locking member 31 (an imaginary line is indicated by a broken line) is formed below the right end member 22, and it is locked with respect to the locked portion 32 formed below the right rail straddling portion 30.

The left end member 23 is formed with a cross-sectional shape associated with a shape of a left cylindrical hole of the central member, and a base side spur tooth portion 37 is formed on the side facing the rail. Further, a lower locking portion (not shown) is formed below the left end member 23 as described above, and it is locked with respect to a locked portion (not shown) formed on the left lower side of the rail straddling portion. When the base 20 is used as a member of the device fixing structure that straddles one rail, the left end member 23 is rarely removed after being fitted to the central member 21. Therefore, a tongue portion is not formed to the left rail straddling portion 29 of the central member 21, and finger grip portions are not formed on both the side edge portions of the left end member. The left end member may be integrally formed with the central member as a matter of course and, on the other hand, the finger grip portions may be certainly formed on the left end member so that the left end member can be easily attached/detached.

An attachment procedure for attaching the base 20 to the rail 10 will now be described. First, a device 38 is screwed and fixed to the central member 21 having the left end member 23 previously attached thereto. Furthermore, the constricted portion of the central member 21 of a base material is placed at a desired position that straddles the flange portions on both sides of the rail 10. Then, the right end member 22 is inserted from the cylindrical hole of the central member 21, the push-down portion 35 of the central member is pushed down, and the right end member 22 is further pressed toward the rail. Moreover, the base side spur tooth portion 36 of the right end member is meshed with the rail side spur tooth portion 15, the locking portion 31 is locked with respect to the locked portion 32, the right end member is fitted to the central member, and its position is fixed. In the attachment procedure, the device 38 is fixed and then the base 20 is attached to the rail 10, but it is needless to say that the base 20 may be attached to the rail 10 and then the device 38 may be fixed to the base 20.

Additionally, in case of adjusting a position of the device 38, the base side spur tooth portion 36 of the right member is detached from the rail side spur tooth portion 15, the central member 21 is slightly moved to the left side in this state, the base side spur tooth portion 37 on the left side is detached from the rail side spur tooth portion (not shown) bonded to the side surface of the rail, the central member 21 is slid in a direction along which the rail 10 extends and adjusted to a desired position, then the right end member 22 is fitted to the central member 21, and the base 20 is placed and fixed to the rail. When a difference between the constricted portion straddling the rail and a width of the rail is small, it is possible to use a portion of the left end member that engages with the rail as a supporting point, lift up the right side of the base 20, move the left end member to a desired position, mesh the base side spur tooth portion 37, then fit the right end member 22 to the central member 21, and effect locking. In case of fixing a device having a predetermined width along the rail 10, two bases placed apart from each other by a length substantially equal to the width of the device may be mounted on the rail, respectively, their positions may be adjusted, and the device may be attached and fixed.

A description will now be given as to an example where two central members 21, one right end member 22, one left end member 23, and one coupling member 40 constitute a coupled base 41 that straddles two rails 10, 10 with reference to FIG. 3 and FIG. 4. The coupled base 41 is formed by coupling the left end member 23, the central member 21 on the left side, the coupling member 40, the central member 21 on the right side, and the right end member 22 from the left side. FIG. 4 is a perspective view for explaining a device fixing structure that fixes a device 42 to the coupled base 41 that is in the coupled state and further fixes them to two DIN rails 10, 10.

Here, the coupling member 40 has a shape that a shape of a left portion of the right end member 22 having no left spur teeth formed thereon is provided on the left side and a shape of a right portion of the left end member 23 having no right spur teeth formed thereon is provided on the right side. The coupling member 40 has a length associated with a length of an interval between the two DIN rail 10, 10, and it can be a length that enables a constricted portion 43 of the left central member 21 and a constricted portion 44 of the right central member to straddle the two rails 10, 10 in a state that the coupled member 41 is configured.

The device 42 is screwed and fixed to nuts 46, which slide in a space below a slit of the base, by screws 45 in a bottom portion thereof (see FIG. 4). To adjust a position of the device 42 in a direction crossing the rails 10, the screws 45 are loosened, the position of the device 42 is adjusted in a direction along which the central members 21, 21 extend in this state, and the screws 45 are fastened and fixed. Further, to adjust the position in the extending direction of the rails 10, a base side spur tooth portion 37 of the left end member of the coupled base 41 is detached from a left rail side spur tooth portion (not shown), a base side spur tooth portion 36 of the right end member of the same is detached from a right rail side spur tooth portion 15, the position of the coupled base is adjusted, and then the respective spur tooth portions are again meshed and fixed. As a result, the position of the device 42 can be adjusted in the two directions along top surfaces of the two rails.

A description will now be given as to the device fixing structure that fixes an effector fixture 48 to the coupled base 41 and further fixes the coupled base to the rails 10. In a perspective view of FIG. 5, a state that an effector 47 is separated from the effector fixture 48 will be explained. The effector fixture 48 is constituted of four fixing members 49 that are separated so that corner portions of the effector 47 can be mounted thereon. Each fixing member 49 has a rectangular shape as seen in a plan, an effector holding piece whose upper side is divided into upper protruding pieces 50 and 51 is respectively formed at each corner thereof, and the effector is held in contact with each corner of the effector. A string locking piece 53 configured to lock a string 52 that fixes the effector 47 is protruded on the lower side of the fixing member 49.

Furthermore, each fixing member 49 is formed of a base member 54 and a lid member 55. A recess portion that is recessed in two levels is formed in a flat portion of the base member 54. A screw hole is formed at a central part of a lower recess portion 56, and a screw having a hexagonally formed screw head is inserted into the base member 54 from the lower side of the slit in the central member 41 through the screw hole. Moreover, the screw is screwed into a nut 57 in the lower recess portion 56, and the base member 54 is fixed to the central member 41. Additionally, a cutout portion 58 that forms a gap with respect to the lid member is provided at a position apart from the effector holding piece. Additionally, a through hole 60 pieced to reach the lower side of the base member is formed in the upper recess portion 59 near the effector holing piece.

The lid member 55 is formed into a shape associated with the upper recess portion 59 of the base member. Further, a shaft portion 61, which is protruded downward from the through hole 60 with the lid member 55 covering the base member 54, is formed. To remove the lid member 55 from the base member 54, the cutout portion 58 is pried while pushing up the shaft portion 61 protruded downward, and the lid member 55 is lifted up so that it can be removed. The lid member 55 is removed or attached in accordance with shapes of leg portions formed on the bottom portion of the effector 47, and the effector 47 is thereby fixed.

The effector 47 is mounted on the effector fixture 48, and the string 52 is fastened to the string locking piece 53 so that the effector 47 can be retained from above, thereby fixing the effector 47. Here, an elastic string is preferable as the string 52. When binding is effected with the elastic string, attachment/detachment of the effector 47 can be facilitated. However, the string is not restricted to the elastic string, and fixation may be carried out with use of a resin binding band. In a state that the effector 47 is fixed to the effector fixture 48, when a gap is provided between the effector 47 and the upper protruding pieces 50 and 51, a rubber ring 62 is attached to the upper protruding pieces 50 and 51 to prevent a gap from being formed between the protruding pieces 50 and 51 and the effector 47, and fixation is effected.

As a base to which the effector fixture 48 is fixed, a coupled base 41 is used. Each fixing member 49 is attached to the central member 21 of each coupled base 41 (see FIG. 3) through a screw as described above. The coupled base 41 is mounted across the two rails 10, 10, and its position is fixed by allowing spur tooth portions formed on lateral sides of the left end member 23 and the right end member 22 facing the rails to mesh with outer rail side spur tooth portions 15 provided on side surfaces portions of the two rails 10, 10. The meshing state of the right end member 22 is released, and each coupled base 41 is slid in the direction parallel to each rail 10, or the right side of the coupled base 41 is lifted up, thereby adjusting a fixing position. In the direction crossing each rail, the effector 47 is removed, and positions of the effector fixture 48 and the coupled base 41 may be adjusted in this state.

A state that effectors having different sizes are densely arranged on an effector board will now be described with reference to FIG. 6. In an effector board 1, four DIN rails 10 are aligned in parallel and fixed. A plurality of effectors 63 to 69 that are different in size are aligned on the DIN rails 10 at positions desired by a performer (in FIG. 6, some of the effectors alone are represented by solid lines). In regard to the effector 63 that is long in a front-and-back direction, a coupled base is configured to cut across the four DIN rails, and spur tooth portions on the outermost rail side surface portions are meshed with spur tooth portions of a left end member and a right end member, whereby fixation is achieved. The effectors 64 to 69 in different sizes shown in FIG. 6 are fixed in proximity to each other so that the performer does not have to largely move his/her toe. Further, when a power supply cable 70 and a signal cable 71 extending from the effectors are placed at positions where they interfere with each other, the effectors 65 and 66 are fixed so as to deviate from each other in the front-and-back direction (an up-and-down direction in FIG. 6). When the effector board 1 is configured as described above, the effectors can be highly densely arranged by utilizing a space corresponding to the size of the effector board 1.

### Example 2

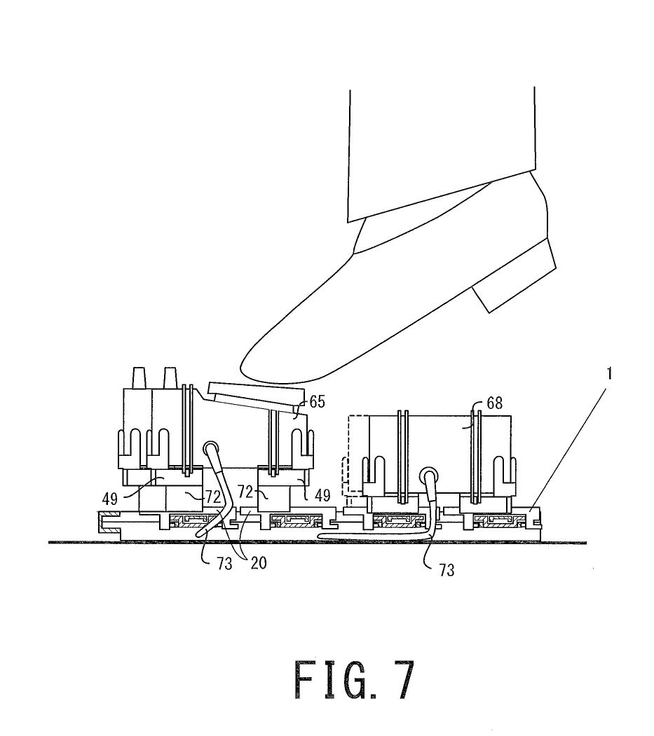

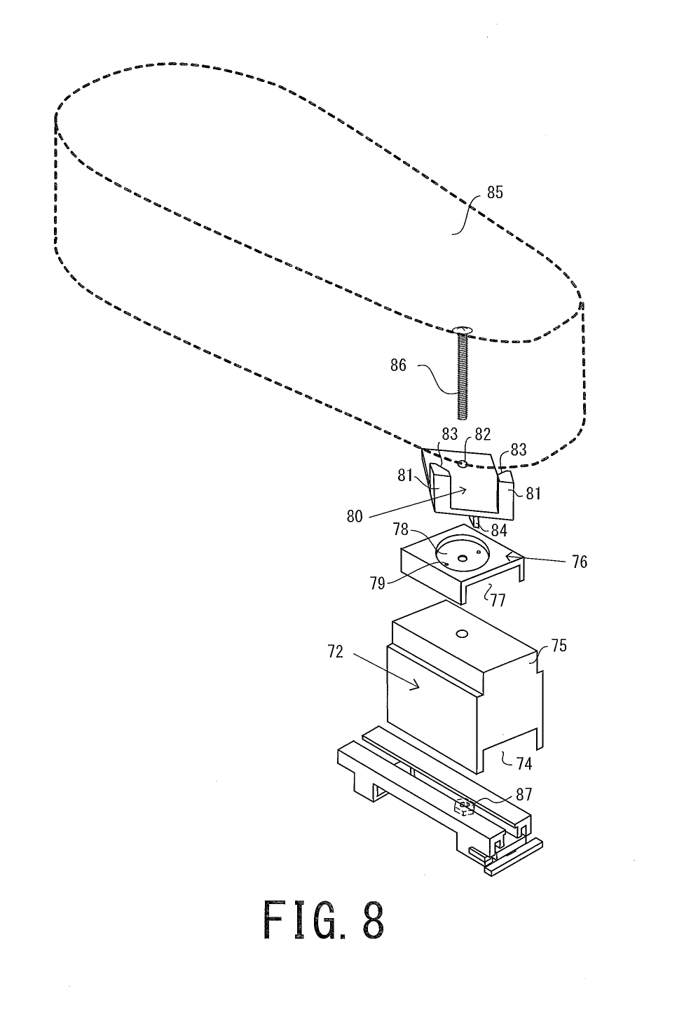

In Example 2, a description will be given as to an example of a device fixing structure that is constituted of device fixing members including height adjusting means with reference to FIG. 7. FIG. 7 is a cross-sectional view taken along a position A-A in FIG. 6. It shows a state that a front effector device 65 far from a performer is fixed on an effector board 1 at a high position and a rear effector device 68 close to the performer is fixed on the same at a low position. Each fixing member 49 of the effector according to Example 2 is supported on a base 20 through a device fixing member 72 forming height adjusting means. The device fixing member 72 forming the height adjusting means has a substantially rectangular parallelepiped shape, a recess portion 74 straddling the coupled base 20 is formed on a bottom portion of this member, and a narrow portion 75 having the same width as the coupled base is formed on a top portion of the same (see FIG. 8). Although the device fixing member 72 is formed of a single member, it may be a desired height adjusting member formed by overlapping members having appropriate heights.

The front effector 65 is mounted on the effector fixing member 49 through the device fixing member 72 forming the height adjusting means, and it is fixed at a higher position than the rear effector 68. As a result, when a performer operates a pedal switch on the front effector 65 with his/her toe, the rear effector 68 does not become an obstacle (see FIG. 7). Furthermore, since wiring cables 73 extending from the respective devices are arranged in a separation space between the effector board 1 and a floor surface, even if a plurality of devices are aligned, the wiring cables do not obstruct performance.

### Example 3

In Example 3, a device fixing member that is pivotally supported and fixed on the height adjusting means explained in Example 2 will be described. A recess portion 77 having the same width as a base is formed on a bottom portion of a lower member 76 of the pivotally supported device fixing member so as to be fitted onto a narrow portion 75 on a top portion of the height adjusting means. Moreover, a circular recess portion 78 having a circular shape is formed on the top portion, and a small protrusion 79 is formed on the circular recess portion. Two columnar bodies 81 extending upward are provided on a top surface of an upper member 80 at positions apart from each other. Each of the two columnar bodies 81 has a device holding surface 83 extending toward an axis of a pivot support hole 82, and it has a string locking piece 84 formed on a lower side thereof. Additionally, a convex portion having a shape associated with the circular recess portion 78 of the lower member is formed on a lower surface of the upper member 80, irregularities (not shown) are continuously provided on the convex portion so as to radially extend from the shaft hole, and they engage with the small protrusion 79 to lock rotation in a state that the upper member and the lower member are fixed through a screw 86.

The upper member 80 overlapped and screwed to the lower member 76 is fitted onto the height adjusting member 72, and it is screwed to a nut 87 in a space below a base slit by the screw 86. Since pivoting around the pivot support hole 82 is possible, even if a device 85 to be fixed has an odd shape imitating a human sole shape, the device holding surfaces 83 of the two columnar bodies are brought into contact with a peripheral edge of a bottom portion of the device without gap, thereby firmly holding the device 85. The device 85 is mounted on the plurality of device fixing members, and it is held and fixed by a string connecting the string locking pieces 84.

### Other Examples

In the foregoing example, the rail is a rail including the flange portions on both sides thereof, but it may be a rail including a flange portion on one side thereof.

In the foregoing example, although the device to be fixed is explained as the effector, it is needless to say that the device may be, e.g., a power supply device or an electronic board installed in an electrical device housing.

The embodiments disclosed here are illustrative examples in all respects, and it should be considered that the embodiments are not restrictive. The technical scope of the present invention is shown by claims without being restricted to the above explanation, and all modifications are intended to be included in the same meaning and range as the claims.

### REFERENCE SIGNS LIST

1 . . . effector board, 10 . . . DIN rail, 11 . . . lid, 12 . . . resin frame, 13 . . . connecting material, 14 . . . side surface portion, 15 . . . rail side spur tooth portion, 20 . . . base, 21 . . . central member, 22 . . . right end member, . . . left end member, 24 . . slit, 25 and 26 . . . protruding portion, 27 . . . nut, 28 . . . constricted portion, 29 and 30 . . . rail straddling portion, 31 . . . locking portion, 32 . . . locked portion, 33 . . . notch portion, 34 . . . tongue portion, 35 . . . push-down portion, 36 and 37 . . . base side spur tooth portion, 38 . . . device, 39 . . . finger grip portion, 40 . . . coupling member, 41 . . . coupled base, 42 . . . device, 43 and 44 . . . constricted portion, 45 . . . screw, 46 . . . nut, 47 . . . effector, 48 . . . effector fixture, 49 . . . fixing member, 50 and 51 . . . upper protruding piece, 52 . . . string, 53 . . . string locking piece, 54 . . . base member, 55 . . . lid member, 56 . . . lower recess portion, 57 . . . nut, 58 . . . cutout portion, 59 . . . upper recess portion, 60 . . . through hole, 61 . . . shaft portion, 62 . . . rubber ring, 63 to 69 . . . effector, 70 . . . power supply cable, 71 . . . signal cable, 72 . . . device fixing member, 73 . . . wiring cable, 74 . . . recess portion, 75 . . . narrow portion, 76 . . . lower member, 77 . . . recess portion, 78 . . . circular recess portion, 79 . . . small protrusion, 80 . . . upper member, 81 . . . columnar body, 82 . . . pivot support hole, 83 . . . device holding surface, 84 . . . string locking piece, . . . device, 86 . . . screw, 87 . . . nut

1. A device fixing structure comprising: a rail extending in a linear form; and a base that is movable along a top surface of the rail,
the rail comprising: flange-shaped engagement edge portions extending along both side edges thereof; and rail side engaging means on at least one of lateral sides of the rail,
the base comprising: a flat portion arranged along the top surface of the rail; attaching means for attaching a device; and a pair of opposed base side engaging means that are engaged with the rail side engagement edge portions, any one of the base side engaging means including:
sliding means that is slidable in a direction extending toward the rail; and slide locking means for locking the sliding means,
the device fixing structure being configured so that the base side engaging means is meshed with the rail side engaging means and the slide locking means is locked to fix a position of the base in a state where the base is arranged at a desired position, or the base is movable in the extending direction of the rail in a state that the base side engaging means is detached from the rail side engaging means and the slide locking means is unlocked,
wherein the flat portion comprises fixed position adjusting means which has a desired length in a direction crossing the extending direction of the rail and slides the device along a direction of the desired length to perform positional adjustment,
the rail side engaging means comprises a rail side spur tooth portion having resin spur teeth with a desired width bonded thereto at a position of a rail side surface portion below the engagement edge portion, and
the base side engaging means facing the rail side engaging means comprises a base side spur tooth portion constituted of resin spur teeth with substantially the same width as the rail side spur tooth portion on an opposed portion relative to the rail side spur tooth portion.

2. The device fixing structure according to claim 1,
wherein the fixed position adjusting means comprises a slot extending along a length direction of the flat portion, a screw, and a nut, and
the base portion is slid in a direction parallel to the slot and subjected to positional adjustment, and the screw is inserted into the slot and screwed and fixed to the nut.

3. The device fixing structure according to claim 1, comprising a device fixing member that fixes the device to the base,
wherein the device fixing member comprises an upper member and a lower member that are separable, and
the lower member is subjected to positional adjustment in the direction parallel to the rail and fixed, the upper member is overlapped and pivotally supported on the lower member, two columnar bodies that upwardly extend and are apart from each other are provided on a top surface of the upper member, and the two columnar bodies are brought into contact with an edge portion of the device, thereby supporting and fixing the device.

4. The device fixing structure according to claim 1, comprising a device fixing member that fixes the device to the base,
wherein the device fixing member comprises height adjusting means.

5. The device fixing structure according to claim 1,
wherein a separation space is provided between the rail and a platform where the device fixing structure is installed.

6. The device fixing structure according to claim 2, comprising a device fixing member that fixes the device to the base,
wherein the device fixing member comprises an upper member and a lower member that are separable, and
the lower member is subjected to positional adjustment in the direction parallel to the rail and fixed, the upper member is overlapped and pivotally supported on the lower member, two columnar bodies that upwardly extend and are apart from each other are provided on a top surface of the upper member, and the two columnar bodies are brought into contact with an edge portion of the device, thereby supporting and fixing the device.

7. The device fixing structure according to claim 2, comprising a device fixing member that fixes the device to the base,
wherein the device fixing member comprises height adjusting means.

8. The device fixing structure according to claim 3, comprising a device fixing member that fixes the device to the base,
wherein the device fixing member comprises height adjusting means.

9. The device fixing structure according to claim 6, comprising a device fixing member that fixes the device to the base,
wherein the device fixing member comprises height adjusting means.

10. The device fixing structure according to claim 2,
wherein a separation space is provided between the rail and a platform where the device fixing structure is installed.

11. The device fixing structure according to claim 3,
wherein a separation space is provided between the rail and a platform where the device fixing structure is installed.

12. The device fixing structure according to claim 4,
wherein a separation space is provided between the rail and a platform where the device fixing structure is installed.

13. The device fixing structure according to claim 6,
wherein a separation space is provided between the rail and a platform where the device fixing structure is installed.

14. The device fixing structure according to claim 7,
wherein a separation space is provided between the rail and a platform where the device fixing structure is installed.

15. The device fixing structure according to claim 8,
wherein a separation space is provided between the rail and a platform where the device fixing structure is installed.

16. The device fixing structure according to claim 9,
wherein a separation space is provided between the rail and a platform where the device fixing structure is installed.
